(19) United States
(12) Patent Application Publication
(10) Pub. No.: US 2021/0213425 A1
(43) Pub. Date: Jul. 15, 2021

(54) THREE-WAY-CATALYST

(71) Applicant: UMICORE AG & CO. KG, Hanau-Wolfgang (DE)

(72) Inventors: Masashi NAKASHIMA, Hyogo (JP); John G. NUNAN, Tulsa, OK (US); Ryan J. ANDERSEN, Owasso, OK (US); Curt M. ELLIS, Bixby, OK (US)

(73) Assignee: UMICORE AG & CO. KG, Hanau-Wolfgang (DE)

(21) Appl. No.: 16/740,956

(22) Filed: Jan. 13, 2020

(51) Int. Cl. B01J 23/46; F01N 3/10; F01N 3/035; B01J 23/44

(52) U.S. Cl. CPC B01J 23/464; F01N 3/101; F01N 3/035; F01N 2510/0684; B01J 23/44; F01N 2370/02; F01N 3/105

(57) ABSTRACT

The present invention relates to a three-way catalyst (TWC) for treatment of exhaust gases of internal combustion engines operated with a predominantly stoichiometric air/fuel ratio, so called spark ignited engines.

The present invention relates to a three-way catalyst (TWC) for treatment of exhaust gases from internal combustion engines operated with a predominantly stoichiometric air/fuel ratio, so called spark ignited engines.

It is well known in the field of internal combustion engines that fuel combustion is not complete and as a result gives emissions of pollutants like unburned hydrocarbons (HC), carbon monoxide (CO), nitrogen oxides (NOx) and particulate matter (PM). In order to improve air quality, emission limit legislations are in place to achieve lower emissions of pollutants from stationary applications and from mobile sources. For mobile sources like passenger cars, the implementation of active strategies such as improved combustion and optimized A/F or lambda control have been carried out in an effort to decrease the emission of pollutants. Improvement of fuel-air mixing (A/F ratio) as a primary measure yielded considerable diminution of pollutants. However, due to more stringent legislations over the years, the use of heterogeneous catalysts has been made inevitable.

For gasoline engines, so-called three-way catalysts (TWC) enable the elimination of HC, CO and NOx. Such catalysts contain catalytically active material consisting of one or more platinum group metals, in particular platinum, palladium and/or rhodium.

Maximum conversion for CO, HC and NOx by the TWC catalyst is around Lambda=1+/−0.005 where the air/fuel ratio is equal to about 14.56. Above these values, the exhaust gas is said to be lean and contains an excess of oxidants such as O₂ and NOx, and CO and HC are catalytically oxidized to carbon dioxide and water. Below this value, the exhaust gas is said to be rich and contains an excess of reductants such as H₂, CO and HCs and mainly NOx is reduced to nitrogen using e.g. CO as a reducing agent.

While maximum conversion of HC, CO and NOx is achieved at Lambda=1, gasoline engines operate under continually oscillating conditions between slightly lean and slightly rich conditions. In order to broaden the optimal operation of a TWC, oxygen storage components (OSCs) in the form of cerium-zirconium mixed oxides are included in its formulation.

Highly concentrated platinum group metals (PGMs) like platinum, palladium and rhodium, can give significant performance improvements in many exhaust after-treatment applications. Thus, in the case of palladium, the light-off performance can be improved by 100° C. (measured as temperature for 50% conversion) by increasing the Pd load from 20 g/L (0.7 g/l) to higher loadings of 100 g/L (3.5 g/l) after moderate to severe aging. Performance does improve above these loadings but the performance gradient with respect to palladium loading is low and very high palladium loads are required for an appreciable impact. The same general trend is expected for rhodium in TWC applications.

However, high concentrations of platinum group metals in three-way conversion catalysts are not favored because of their high cost. This drawback can be partially overcome by strategic placement in small size monoliths with high cell density located close to the engine manifold. This strategy takes advantage of hotter exhaust gas temperatures that shorten the time for cold start as the monolith heats faster. The lower mass coupled with high cell density takes advantage of lower thermal inertia coupled with faster heat transfer to the close coupled (CC) monolith.

A further strategy for improved light-off and for lowering platinum group metal cost is to selectively locate it on a small section of the monolith, often less than 10% of the monolith volume where it has the greatest benefit. This allows us to concentrate the platinum group metal while not using a large quantity.

It is known in the literature that highly concentrated and short zones of platinum group metals, when applied to the substrate inlet, give improved cold start performance due to improved light-off, especially for hydrocarbon (HC) oxidation as high concentrations of HC are emitted when the engine is cool, and combustion is incomplete. However, the close-coupled monolith can be exposed to a variety of contaminants that remain in place over the lifetime of the vehicle. These include the break-down of partially combusted components from engine oil and include calcium, phosphorous, zinc and boron. These poisons are not deposited uniformly over the length of the monolith but are deposited preferentially towards the inlet of the catalyst and their concentration drops-off rapidly progressing towards the monolith outlet. The fall-off in concentration can be exponential in nature such that the front one to two inches of the monolith can have very high loadings of these components. Depending on how the poisons enter the exhaust two different types of poisoning modes are observed. If the poisons leak into the vehicle combustion chamber the resultant phosphorous and zinc penetrates the washcoat located on the monolith and reacts with its components such as cerium and aluminum. It is believed that phosphorous forms phosphoric acid in this poisoning mechanism and is reactive to such an extent that the normally structurally stable Ce—Zr mixed oxides are broken down to give new compounds. In extreme cases, the cerium can be extracted from the Ce—Zr mixed oxides to give CePO₄ which results in a loss of OSC performance.

In a second mechanism, the engine oil can leak directly into the exhaust after it exits the combustion cylinders. In this case the oil is deposited directly onto the monolith washcoat and decomposes to give zinc pyrophosphate on the surface. If high levels are deposited via this mechanism a surface “glaze” or impermeable barrier on the washcoat surface is formed such that exhaust gas molecules are unable to diffuse to the active platinum group metal component within the washcoat. This is often referred to as masking and is commonly observed for severely oil-poisoned TWC catalysts. A consequence of this type of poisoning is that selective placement of the platinum group metal band or zone at the inlet face of the monolith would be counterproductive as a high fraction of the expensive platinum group metal is not available for catalysis.

Other poisoning mechanisms that selectively target the inlet region of the monolith include washcoat erosion and physical blockage and coating of the washcoat if the inlet face is impacted with particulate matter such as rust originating from the manifold region. In some regions of the world such as China, the inclusion of the octane booster methyl-cyclo-pentadienyl manganese tri-carbonyl (MMT) can decompose on the inlet monolith region to give a layer of Mn₃O₄ which again can act as a physical masking or blocking reagent for exhaust gases that must penetrate to the washcoat for catalysis to occur. In addition to increased reduction in HC, NOx and CO emissions for future applications such as SULEV-20, control of secondary emissions will likely be a further requirement. These include NH₃ and N₂O.

The present invention addresses the problem of poisoning of the catalyst by utilizing the following concept. By providing a catalyst comprising a carrier substrate of the length L extending between substrate ends (a) and (b) and at least three washcoat zones A, B, and C, wherein washcoat zone A comprises Rh and a supporting oxide and extends starting from substrate end (a) over a part of the length L, and washcoat zone C comprises one or more platinum group metals (PGM), and a supporting oxide, and extends starting from substrate end (b) over a part of the length L, and washcoat zone B comprises Pd and a supporting oxide, and extends between washcoat zones A and C, wherein L=L_{A}+L_{B}+L_{C}, wherein L_{A} is the length of washcoat zone A, L_{B} is the length of washcoat zone B and L_{C} is the length of washcoat zone C, a catalyst is generated that surprisingly is less prone to poisoning effects than those known from prior art.

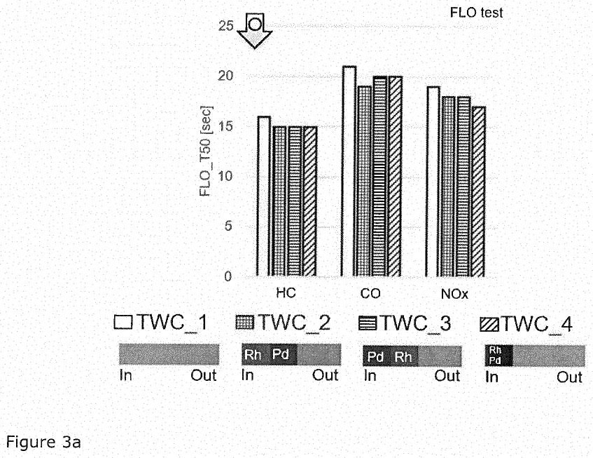

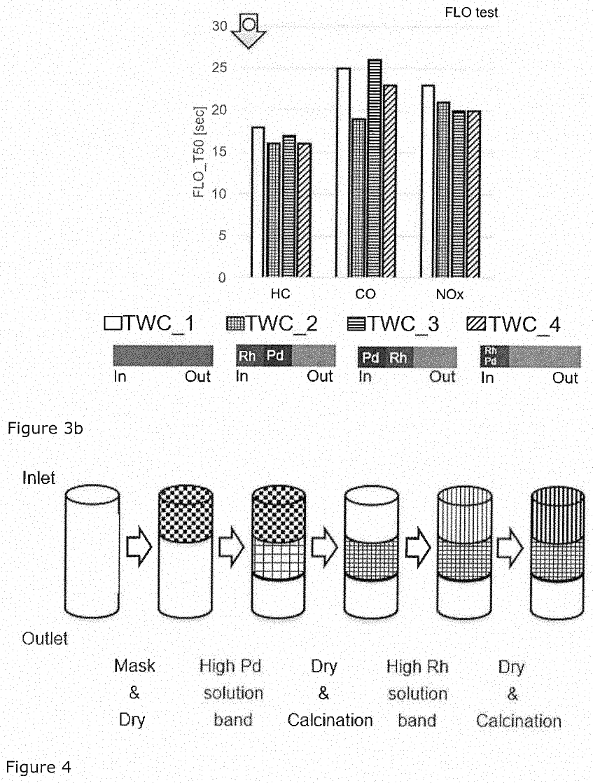

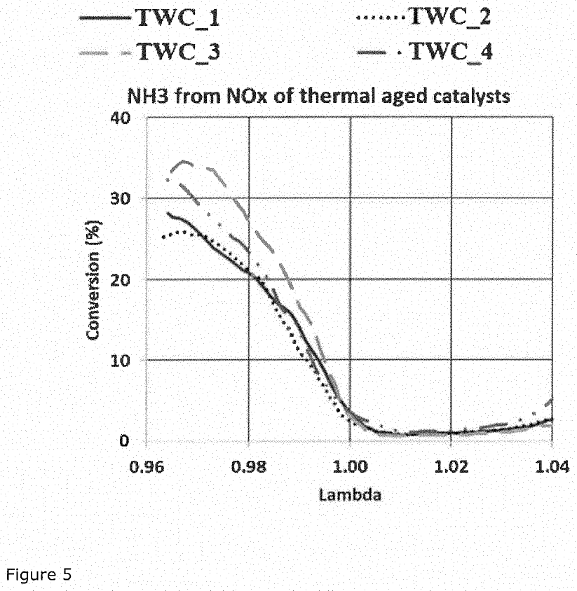

The present invention shows that the above-mentioned disadvantages of zoning and/or banding of the inlet region of the monolith with high platinum group metal concentrations can be overcome by locating the high Pd-zone sufficiently away or back from the inlet region of the monolith as seen from the perspective of gas flow behind a Rh-zone such that the above poisoning and deactivation mechanisms are minimized while still achieving the advantage of improved light-off and subsequent shorter cold start periods on the vehicle. As can be seen in FIGS. 3a and 3b the time needed for 50% conversion (T50-values), in particular for CO, remain well below normally coated TWC catalysts (TWC_1) as well as for the alternate concepts in TWC_3 and TWC4 where one reverses or combines the bands/zones, respectively, as shown in TWC_3 and TWC_4. Thus, it has surprisingly been found by the inventors that banding with two different PGMs strategically located in different regions of the monolith channels relative to each other greatly reduces these emissions, and also for NH₃. The latter is clearly shown in the attached FIG. 5 where a Rh-band located in front of the Pd-band leads to reduced NH₃ formation under stoichiometric and rich conditions.

Platinum group metals (PGM) can be platinum, palladium and/or rhodium and can be present also in zone A and/or B but necessarily in zone C, as long as a relatively high Rh-concentration (preferably >70 wt. %) prevails in zone A and a relatively high Pd-concentration (preferably >70 wt. %) remains in zone B compared to the other PGMs in these respective zones. Preferably, the platinum group metal is palladium and rhodium, in a very preferred aspect palladium and rhodium only.

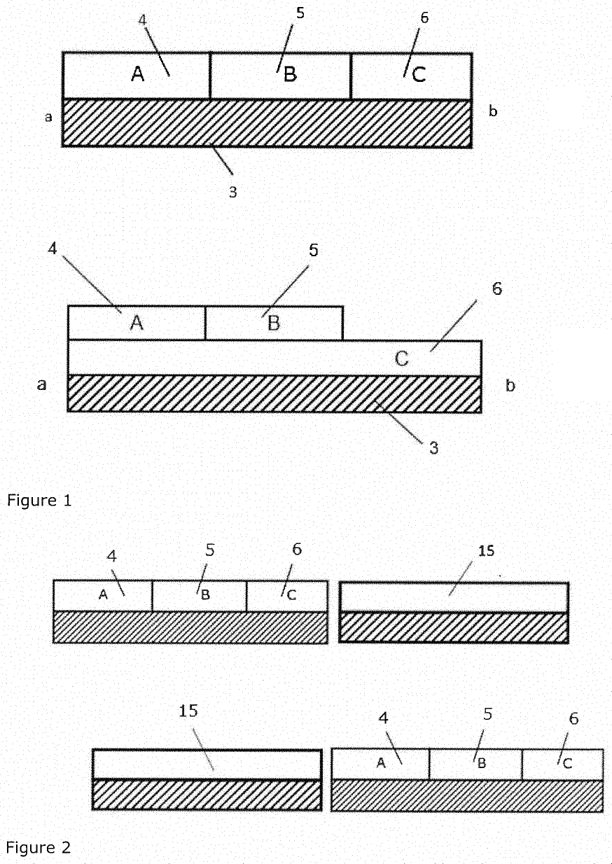

The described zones can be present in a layered format. As a preferred example for this embodiment, the carrier substrate may be coated with platinum group metal containing washcoat over the whole length L first and afterwards, e.g. after drying and/or calcining, be treated according to the present invention with zones A comprising Rh and a supporting oxide and B comprising Pd and a supporting oxide (FIG. 1, lower scheme). Within this embodiment the high Rh (A) and/or Pd (B) bands can be applied by PGM banding without the co-addition of a supporting oxide containing these PGMs. In this case Rh and/or Pd containing zones are established on the already existing platinum group metal containing washcoat (C) applied first over the whole length L and containing the supporting oxide. Other concepts of layering may come to the mind of those skilled in the art though. If Pd and Rh are present in zone C or the layer establishing zone C the weight ratio of Pd:Rh is, for example, from 10:1 to 1:10. The amount of PGM, in particular Pd and Rh in sum, in this washcoat layer or in zone C is typically from 0.1 g/L to 20 g/L, preferably 0.2 g/L to 10 g/L.

As mentioned hereinabove the TWC of the present invention can have a layered format. This means that different layers of the same or different constitution cover each other as seen from the substrate carrier surface towards the gas flow channel. As soon as such a concept (e.g. FIG. 1, lower scheme) is realized only the outermost layers being in direct contact with the exhaust gas stream are deemed as zones A, B and C, respectively. Contrary to the layered approach it is also contemplated with the present invention that the substrate carrier is coated with the Rh-zone A, Pd-zone B and PGM-zone C washcoats in distinct zones only. Because washcoating is not a perfectly precise process when coating in zones the zones A and B and/or B and C may have an overlap region which in most cases is negligible and should not exceed ±10% of L_{A} or L_{C}, respectively (FIG. 1, upper scheme). The layer of zone A comprises Rh in an amount of from 0.2 g/L to 4.0 g/L, preferably of from 0.3 g/L 3.0 g/L, and most preferably as from 0.4 g/L to 2.0 g/L. Likewise, a layer of zone B comprises Pd in an amount of from 0.4 g/L to 20 g/L, preferably of from 1.0 g/L to 15 g/L, and most preferably as from 2.0 g/L to 10 g/L. In an advantageous embodiment this layer zone A comprises only Rh as the PGM. In a preferred embodiment this layer zone B comprises only Pd as the PGM. Most preferred, this layer zone A comprises only Rh as the PGM and this layer zone B comprises only Pd as the PGM, preferably within above mentioned ranges.

The PGMs are normally distributed on a high surface area supporting oxide. Preferably, the supporting oxide is selected from the group consisting of alumina, silica, magnesia, titania, zirconia, ceria, rare earths such as lanthanum neodymium, praseodymium, yttrium and mixtures comprising at least one of these materials and mixed oxides comprising at least one of these materials, Usually, they have a BET surface area of 30 to 250 m²/g, preferably of 100 to 200 m²/g (determined according to German standard DIN 66132 as of the filing date) and are in particular selected from the group consisting of alumina, silica, magnesia, titanic, zirconia, ceria, rare earths such as lanthanum neodymium, praseodymium, yttrium and mixtures comprising at least one of these materials and mixed oxides comprising at least one of these materials. Supporting oxides can have an OSC-activity, these materials being defined later in the text. Further supporting oxides can be used which are known to the skilled person for that purpose. Preferred are alumina, alumina/silica mixed oxides, magnesia/alumina mixed oxides, ceria, ceria/zirconia, rare earths such as lanthanum neodymium, praseodymium, yttrium mixed oxides and zeolites. In case alumina is used, it is preferably stabilized, for example with 1 to 10 weight percent, in particular 1 to 4 weight percent, of lanthana. The different platinum group metals can be supported on the same or on different support materials.

In embodiments of the present invention, washcoat zone A extends over 15 to 50% of the length L of the carrier substrate, preferably 20 to 40%, washcoat zone B extends over 7 to 30% of the length L of the carrier substrate, preferably 15 to 25% and washcoat zone C extends over 20 to 78% of the length L of the carrier substrate, preferably 35 to 65%.

In embodiments of the present invention, the carrier substrate of the length L can be a flow-through or a filter substrate. Such carrier substrates are usually made of cordierite, metal or fibrous material and are described in the literature and are available on the market. Preferred are flow through substrates in this respect.

The present invention is likewise directed to a method for the manufacturing of an inventive catalyst. This method comprises the steps in this order:
a, applying a hydrophobic masking zone extending from substrate end (a) over the length L_{A},
b. coating the carrier substrate from substrate end (a) with a coating to establish a PGM containing washcoat zone B over the length L_{B},
c. removing the masking zone,
d. coating the remainder of the carrier substrate to establish a PGM containing washcoat zones A over length L_{A} and optionally a PGM containing washcoat zone C of length L_{C},
e. drying and/or heating the coated carrier.

The substrate may already have an existing uniform washcoat layer applied with or without precious metals present where the steps “a” to “e” described above are carried out on the already present uniform washcoat layer. This applies e.g. when washcoat zone C is coated onto the whole length L first and zones A and B follow according to steps “a” to “e”. The coating steps are usually performed via conventional immersion, suction and pumping methods which are extensively described in the literature and known to the person of skill in the art.

The precious metals used as either PGM solutions or present in slurries that are applied in zones A, B and C can be the chloride, nitrate, sulfite, acetate, ethanolamine, tetra-alkyl ammonium salts of Pt, Pd and Rh. in the case of the PGM solutions additives can be added that compete for adsorption with the PGM so that the penetration depth of the PGM through the depth of the washcoat can be controlled. These include added chloride for the negatively charged chloride salts and hydroxy-carboxylic acids in the case of chloride, nitrate, acetate, sulfite, ethanolamine and tetra alkyl ammonium salts.

The hydrophobic masking zone can be applied using a number of approaches. In one approach a wax or viscous oil (such as a fatty acid) can be utilized with a melting point just above room temperature and which has a lower viscosity on melting allowing to push the melted wax into the monolith using e.g. a piston type coater (e.g. WO2011098450A1) and removing excess wax or oil with piston retraction so as to give cleared channels with a residual layer of wax or viscous oil on the washcoat surface. The zone length can be controlled precisely by the length of the piston stroke. A number of wax types can be utilized such as paraffin wax which can be derived from petroleum, coal or oil shale. Other types of waxes or viscous oils can be synthesized from ethylene polymerization or polymerization of propylene. Waxes or viscous oils typically consist of a range of hydrocarbons ranging in carbon number from 20 to 70 carbon atoms with alkane components predominating. However, they can also contain a range of functional groups such as fatty acids, primary and secondary long chain alcohols, unsaturated bonds, aromatics, amides, ketones and fatty acid esters.

The melting temperature of waxes can be controlled both by the carbon number in the chains or by control of branching, and the presence of the functional groups mentioned above. Typically, a wax is needed that melts just above room temperature, preferably in the range of 30°-60° C., such as paraffin wax which melts at about 37° C. (99° F.), and have a boiling/decomposition point preferably between 300° and 400° C. Paraffin wax e.g. decomposes/boils at 370° C. Other waxes or oils include naturally derived products such as coconut oil, cocoa butter or others with the appropriate viscosity and melting temperature.

An alternative approach is to use a wax emulsion of high solids content. This approach eliminates the need to heat the wax or oil to get the appropriate viscosity and fluidity. After application of the emulsion the part can be heated for a short period to melt and spread the wax on the washcoat surface to form a continuous hydrophobic layer over the carrier substrate. Waxes and wax emulsions which can be used in the inventive process are known to the skilled person and are available in the market place.

The preferred method of applying washcoat zone B or PGM band is using a precision piston coater, in particular as described in WO2011098450A1, where the exact length of the hydrophobic masking zone and the zone to be contacted with the Pd-comprising washcoat or Pd solution can be controlled as precisely as possible. Pd-washcoats are known to the skilled worker. However, preferred are those which comprise compositions selected from the group of Pd/Al₂O₃, Pd/OSC/Al₂O₃, Pd/BaO/Al₂O₃, Pd/BaO/OSC/Al₂O₃, where the OSC consists of a complex mixture and/or solid solution of cerium, zirconium and rare earth or alkaline earth oxides.

Since the application of the high concentration Pd-washcoat or Pd solution zone B is done after application of the masking zone the process is very flexible and not technology-specific with respect to washcoat composition or the number of washcoat passes. Simply, the washcoat of the Pd-zone B metal traverses over the masked zone without the Pd being adsorbed, while adsorption only occurs on the zone B of carrier substrate or already wash-coated substrate beyond the masking zone. This zone length can be easily determined and controlled by knowing the length of the masked zone.

In a further step, the masking zone has to be removed again. This can be done by for example dissolving the fatty acids in an alkaline medium or by drying and heating such that the hydrophobic masking zone is completely burned off. The temperatures applied are usually between 400 and 600° C.

In a following step, the washcoat A or if still necessary the washcoat zone C can be applied. The sequence is not important since both washcoats would have to be applied from different ends (a) or (b) of the carrier substrate which can be an already coated substrate. Again, the preferred method of applying washcoat zone A or C is using a precision piston coater like mentioned above where the exact length of the zones can be controlled as precisely as possible. Rh-washcoats for zone A are known to the skilled worker. However, preferred are those which comprise compositions selected from the group of Rh/Al₂O₃, Rh/OSC/Al₂O₃, Rh/BaO/Al₂O₃, RhPd/BaO/OSC/Al₂O₃ where the OSC consists of a complex mixture and/or solid solution of cerium, zirconium and rare earth or alkaline earth oxides. Likewise, PGM-containing washcoats for zone C are state of the art and can be chosen according to one skilled in the art. Preferred washcoats for zone A and C, however, comprise Rh/OSC/Al₂O₃. If coated in zones the zones applied on the carrier substrate according to the method of the invention can overlap to a certain extend because the precision of the coating might not be accurate enough. However, it should be understood that an inevitable overlap or gap between the zones should be as minimal as possible. As already indicated the overlap does not exceed ±10% of L_{A} and/or L_{B}, respectively.

In a last step, drying, heating and/or calcining can occur in order to provide the ready to use substrate carrier catalyst. Preferably, the steps “b” and/or “d” as mentioned above are usually followed by drying and/or calcination under air and optionally thermal reduction in an atmosphere which contains forming gas. When coated in zones it is most preferred that zone A and zone C are coated consecutively without a drying or calcination step in between.

The catalyst of the present invention is suitable for the treatment of exhaust gases from engines operated with a predominantly stoichiometric air/fuel ratio, the treatment of the exhaust gas being carried out by passing the exhaust gas over the inventive catalyst. In particular, it can be advantageously used in a close-coupled position, preferable as the first catalyst located directly after the exhaust manifold (so-called CC-1 position).

The catalyst of the present invention can be combined with another three-way catalyst, a gasoline particulate filter, a HC trap and/or a NOx trap to form a three-way catalyst system. For example, substrate end (b) of the catalyst of the present invention can be followed by a conventional three-way catalyst, eventually the latter being located on a wall flow filter substrate. Also, substrate end (a) of the catalyst of the present invention can follow a conventional three-way catalyst, eventually the latter being located on a wall flow filter substrate.

As conventional three-way catalysts all three-way catalysts known to the skilled person and described in the literature can be used. Usually they comprise a platinum group metal, in particular palladium and rhodium, supported on a carrier material, as well as an oxygen storing component (OSC). In the context of the present invention OSC materials are preferably doped cerium-zirconium mixed oxide. Dopants are advantageously those selected from the group consisting of Pr, La, Nd, Y in an amount of less than 10 wt.-%, better 5 wt.-% based on the total cerium-zirconium mixed oxide.

Besides three-way-catalysts, other emission control technologies may be alternatively utilized not only as a uniform bottom layer but also as the various zones in regions A, B and C. These alternate technologies could include hydrocarbon and NOx trap washcoats and various combinations of these. Further the order in which these various technologies are applied can vary depending on the application. For example, the uniform bottom layer could consist of a HC trap or TWC washcoat, zone A a NOx trap washcoat further containing Pt, zone B a TWC washcoat and zone C a Cu or Fe based SCR washcoat.

The present invention is also concerned with a method for treating exhaust gases of a combustion engine, wherein the exhaust gas is passed over the catalyst of the invention, wherein it enters the catalyst at substrate end (a) and exits it at substrate end (b). In a preferred method the catalyst of the invention is arranged in close coupled position of less than 1 m, preferably less than 60 cm and most preferably less than 50 cm behind the engine outlet. In a preferred method for treating the exhaust the combustion engine is a spark ignition engine. Again, this method is characterized in that the exhaust gas is passed over the catalyst of the invention, wherein it enters the catalyst at substrate end (a) and exits it at substrate end (b). Spark ignition engines are those selected from the group consisting of gasoline direct injection engines, port fueled engines, naturally aspirated gasoline engines.

In addition to using the catalyst of the present invention for the treatment of exhaust gases of engines operated with a predominantly stoichiometric air/fuel ratio, it can also be used as a diesel oxidation catalyst for the treatment of exhaust gases emitted from a lean burn engine, like diesel engines. Accordingly, the present invention further relates to a method for treating the exhaust gas of a lean-burn engine, characterized in that the exhaust gas is passed over an inventive catalyst wherein it enters the catalyst at substrate end (a) and exits it at substrate end (b). When used as a diesel oxidation catalyst, the catalyst of the present invention can be combined with other components of a catalyst system for the treatment of learn burn exhaust gases. Examples of such components are active NOx storage catalysts, passive NOx storage catalysts, diesel particle filters and SCR catalysts.

The present invention provides a catalyst for better TWC-performance. This goal was achieved by selecting a certain zoned design in combination with a certain PGM distribution. It was not obvious from the prior art that this combination would result in a better mitigation of noxious pollutants like CO, HC and also NH₃.

FIG. 1 illustrates catalysts according to the present invention. The upper part of the figure shows a detail of an inventive catalyst (1) which comprises a carrier substrate (3) which extends between substrate ends (a) and (b) and which carries washcoat zone A (4), washcoat zone B (5) and washcoat zone C (6).

The lower part of the figure shows a detail of an inventive catalyst (2) which comprises a carrier substrate (3) which extends between substrate ends (a) and (b) and which carries washcoat zone A (4), washcoat zone B (5). Washcoat zone C (6) is coated as a layer of the whole length of the catalyst.

FIG. 2 illustrates catalyst systems according to the present invention.

The upper part shows an inventive catalyst system (13) which comprises an inventive catalyst (1) and a conventional three-way catalyst (15). Both catalysts are arranged so that washcoat zone C (6) is followed by the conventional three-way catalyst (15).

The lower part shows an inventive catalyst system (14) which comprises an inventive catalyst (1) and a conventional three-way catalyst (15). Both catalysts are arranged so that washcoat zone A (4) follows the conventional three-way catalyst (15).

FIGS. 3a and b shows the results of a poisoned fresh (a) and thermally aged (b) catalyst of the invention in comparison with reversed design and prior art designs.

FIG. 4 shows the production process in a graphical fashion,

FIG. 5 depicts the better NH₃ performance of poisoned catalyst according to the invention in comparison with reversed design and prior art designs under rich conditions.

### EXPERIMENTAL PART

The four experimental parts, TWC_1, TWC_2, TWC_3 and TWC_4 shown e.g. in FIG. 3a, FIG. 3b have the same total PGM and washcoat loading. The total Pd loading was 4.51 g/L, the total Rh loading was 0.12 g/L, and the total washcoat loading was 159 g/L. The substrates utilized were of identical dimensions and cell density and consisted of ceramic substrates that were φ118.4 mm×T91 mm, 900 cell/2.5 mill cell structure. TWC_1 is the reference experimental part with the homogeneous washcoat layer.

TWC_2, TWC_3 and TWC_4 were built as follows. The monoliths were coated with a homogeneous washcoat load of 159 g/L containing 1.75 g/IL of Pd and 0.12 g/L of Rh (zone C), a high Pd loading of 10 g/L (zone B) and a high Rh loading of 1 g/L (zone A).

The masking band was applied by vacuuming from one end of the monolith using 55 g of 59 wt.-% solid content of polyurethane emulsion to a length of 25.4 mm from the one end of the monolith. Different emulsions can also be used to mask a zone. The masked part was dried in an oven at 110° C. for 12 hours so the masking agent formed a solid uniform water-impervious layer over the zone in the inlet of the part.

The application of the Pd-band or zone B was carried out as follows. An aqueous solution consisting of a thickening agent in water was prepared. This was added to control and limit wicking of the aqueous Pd-solution when applied to give the banded zone. The thickening agent was added at 0.5 wt % based on the total weight of solution. Different surfactants can also be used to lower the surface tension of the Pd-solution and minimize wicking thus improving control of the Pd-band length. To this solution was added Pd tetra-amine acetate at a concentration that was determined based on the Pd-loading target in the banded zone, the band/zone length and the amount of solution need to reach the end of the banded zone when injected over the masked zone assuming no solution or Pd uptake on the masked zone. To determine the Pd-solution concentration an initial wet weight uptake for the monolith was measured using a solution of the thickening agent in water without the Pd-salt present. In the current example the masked zone length was 25.4 mm and the target Pd-zone/band length was 25.4 mm. After application of the Pd-band, the excess solution was removed by vacuuming from the injection end of the monolith. The banded/zoned part was then calcined in an up-flow forced air oven with the masking band located at the top of the monolith. The calcination temperature was 550° C. for 30 minutes.

The application of the Rh-band or zone was carried out as follows. An aqueous solution consisting of a thickening agent in water was prepared. This was added to control and limit wicking of the aqueous Rh-solution when applied to give the banded zone. The thickening agent was added at 0.5 wt % based on the total weight of solution. Different surfactants can also be used to lower the surface tension of the Rh-solution and minimize wicking thus improving control of the Rh-band length. To this solution was added Rh tetra-amine acetate at a concentration that was determined based on the Rh-loading target in the banded zone, the band/zone length and the amount of solution need to reach the end of the banded zone. To determine the Rh-solution concentration an initial wet weight uptake for the monolith was measured using a solution of the thickening agent in water without the Rh-salt present. After application of the Rh-band, the excess solution was removed by vacuuming from the injection end of the monolith. The banded/zoned part was then calcined in an up-flow forced air oven. The calcination temperature was 550° C. for 30 minutes.

TWC_2 was built in the process order shown in FIG. 4. The masking process was carried out first, then the Pd-band was established to 50.8 mm from the inlet which was followed by the Rh-band process to 25.4 mm from the inlet, after removal of the masking zone. The PGM-zone C was afterwards applied from outlet end (b).

Comparison testing was carried out using TWC_3 and TWC_4.

TWC_3 was built by switching the process order of Pd-band process and Rh-band process on TWC_2. TWC_4 was built as the reference experiment part. Pd-band process was carried out and then Rh-band was applied in the same zone as the Pd-band.

### Evaluation on Engine Dyno Bench

Four parts of TWC_1, TWC_2, TWC_3 and TWC_4 were engine aged to a full useful life 100,000 miles condition using a specific accelerated aging cycle. The cycle consisted of repetitive two seconds rich/rich followed by 5 seconds of air-injection for 50 hours. The peak temperature during air injection measured one inch from the catalyst inlet face was 1050° C.

After the above aging, poison aging was carried out on the same engine using a fuel that was doped with 0.1 wt % of a phosphorous compound. The doping level was such that after 50 hours of stoichiometric aging at 700° C. the catalysts was loaded with 6.6 g of P₂O₅ assuming all the phosphorous was adsorbed by the catalyst.

The aged catalysts were evaluated on a stand dyno using a 6.0 L GM engine before/after poisoning aging. The catalysts were connected to the exhaust manifold using a stainless-steel pipe. The test results are shown in FIGS. 3-a, 3-b and 5.

The FLO (Fast Light-Off) testing was carried out using a 21.4 g/sec exhaust gas flow. The mean lambda of the exhaust gas was 1.000 with a lambda modulation of ±0.045 at 1 Hz. Data was collected at 1 Hz. Initially the catalyst was heated by the exhaust gas to 500° C. or close to 500° C. after which it was cooled down. During cool-down the exhaust was switched to a bypass line so that it did not pass through the catalyst. When the bed temperature of the catalyst was cooled to 50° C. the exhaust was switched from the by-pass line to the on-line position, so exhaust now passed through the catalyst resulting in the catalyst temperature increasing rapidly. The time needed to reach 50% HC-conversion (T₅₀) was measured and compared for the four catalysts. The results are shown in FIGS. 3-a, 3-b. The catalyst having the lowest T₅₀ number is the preferred one. FIG. 3-a shows the comparisons for the P₂O₅ poisoned parts. FIG. 3-b shows the comparisons after thermal aging and before poisoning. It is observed that TWC_2 of the current invention showed the best performance as it had the lowest T₅ time. This was especially true for CO performance before and after poisoning evaluated using this FLO test.

In order to investigate NH₃ production from NOx, a lambda sweep test on the same stand dyno engine was carried out. A lambda sweep at 600° C. from 1.044/Lean→0.948/Rich with a modulation of ±0.055 at 1 Hz was carried out at an exhaust flow of 54.5 g/sec. The sweeping time was 680 seconds. As shown in FIG. 5, it was found that TWC_1 and TWC_2 had lower NH₃ conversion from NOx on the rich side at lambda values below 0.98 lambda. Based on these results it is evident that the TWC_2 design gave the lowest NH₃ formation from NOx as well as having the lowest T₅₀ for the fast-light-off (FLO) test.

1. Catalyst comprising a carrier substrate of the length L extending between substrate ends a and b and at least three washcoat zones A, B, and C, wherein washcoat zone A comprises Rh and a supporting oxide and extends starting from substrate end (a) over a part of the length L, and washcoat zone C comprises one or more platinum group metals, and a supporting oxide, and extends starting from substrate end (b) over a part of the length L, and washcoat zone B comprises Pd and a supporting oxide, and extends between washcoat zones A and C, wherein L=L_{A}+L_{B}+L_{C}, wherein L_{A} is the length of washcoat zone A, L_{B} is the length of washcoat zone B and L_{C} is the length of washcoat zone C.

2. Catalyst according to claim 1, wherein zone A comprises Rh in an amount of from 0.2 g/L to 4.0 g/L.

3. Catalyst according to claim 1, wherein zone B comprises Pd in an amount of from 0.4 g/L to 20 g/L.

4. Catalyst according to claim 1, wherein zone A comprises only Rh as the PGM.

5. Catalyst according to claim 1, wherein zone B comprises only Pd as the PGM.

6. Catalyst according to claim 1, wherein the supporting oxide is selected from the group consisting of alumina, silica, magnesia, titania, zirconia, ceria, rare earths such as lanthanum neodymium, praseodymium, yttrium, mixtures comprising at least one of these materials and mixed oxides comprising at least one of these materials.

7. Catalyst according to claim 1, wherein washcoat zone A extends over 15 to 50% of the length L of the carrier substrate, washcoat zone B extends over 7 to 30% of the length L of the carrier substrate and washcoat zone C extends over 20 to 78% of the length L of the carrier substrate.

8. Catalyst according to claim 1, wherein the carrier substrate of the length L is a flow-through or filter substrate.

9. Method for the manufacturing of a catalyst according to claim 1 comprising the steps in this order:
a. applying a hydrophobic masking zone extending from substrate end (a) over the length L_{A},
b. coating the carrier substrate from substrate end (a) with a coating to establish a PGM containing washcoat zone B over the length L_{B},
c. removing the masking zone,
d. coating the remainder of the carrier substrate to establish a PGM containing washcoat zones A over length L_{A} and optionally a PGM containing washcoat zone C of length L_{C},
e. drying and/or heating the coated carrier.

10. Catalyst system comprising a first catalyst according to claim 1 and another three-way catalyst, a gasoline particulate filter, a HC trap and/or a NOx trap.

11. Catalyst system according to claim 10, wherein substrate end (b) of said first catalyst is followed by the another three-way catalyst.

12. Catalyst system according to claim 10, wherein substrate end (a) of said first catalyst is followed by the another three-way catalyst.

13. Method for treating exhaust gases of a combustion engine, wherein the exhaust gas is passed over the catalyst of claim 1, wherein it enters the catalyst at substrate end (a) and exits it at substrate end (b).

14. Method according to claim 13, wherein said catalyst is arranged in close coupled position.

15. Method for treating the exhaust gas of a spark ignition engine, characterized in that the exhaust gas is passed over the catalyst of claim 1, wherein it enters the catalyst at substrate end (a) and exits it at substrate end (b).
